(19) United States
(12) Patent Application Publication
(10) Pub. No.: US 2026/0241584 A1
(43) Pub. Date: Aug. 20, 2026

(54) FOLDING KNIFE

(71) Applicant: Seiichi NAKAMURA, Seki City, Gifu (JP)

(72) Inventor: Seiichi NAKAMURA, Seki City, Gifu (JP)

(21) Appl. No.: 19/164,870

(22) PCT Filed: Jun. 10, 2024
(86) PCT No.: PCT/JP2024/020979

§ 371 Date: Sep. 12, 2025

(30) Foreign Application Priority Data
Jun. 20, 2023 (JP) 2023-100969

(51) Int. Cl. B26B 1/04

(52) U.S. Cl. CPC B26B 1/04

(57) ABSTRACT

A folding knife includes: a blade; plate-shaped members holding the blade rotatable in a first direction away from an accommodation space and a second direction toward an inside of the accommodation space; a stopper portion abutting on a base of the blade when the blade reaches a fixed position of the grip portion and stopping a movement of the blade in the first direction; a movement restricting portion movable between a first position in a rotation region of the blade and a second position disposed away from the rotation region, the movement restricting portion moving to the first position and fitting into a gap between the stopper portion and a locked portion provided at the base of the blade, thereby restricting a movement of the blade in the second direction; and a manipulator portion enabling a user to manipulate the movement of the movement restricting portion.

### TECHNICAL FIELD

The technology disclosed herein relates to a folding knife.

### BACKGROUND ART

For example, Patent Literature 1 listed below discloses an example of a folding knife. Generally, folding knives are highly portable since a blade can be folded by being rotated toward a grip portion to be gripped by a user, allowing a cutting-edge portion of the blade to be accommodated within the grip portion.

### CITATION LIST

### Patent Literature

Patent Literature 1: Japanese Patent Application Laid-Open Publication No. 2022-145375

### SUMMARY OF INVENTION

### Technical Problem

It is preferable that the blade is firmly fixed to a grip portion when the folding knife is shifted from a closed state in which the cutting-edge portion is accommodated within the grip portion to an open state in which the blade is positioned at the front end of the grip portion. In the folding knives, there has been still room for improvement in terms of being capable of fixing the blade to the grip portion with a simpler configuration.

The technology disclosed herein aims to provide a folding knife capable of firmly fix a blade to a grip portion, when opened, with a simpler configuration.

### Solution to Problem

It is possible to realize the technology disclosed herein as the following aspects.

[First Aspect] One aspect of the technology disclosed herein is provided as a folding knife. A folding knife according to a first aspect includes: a blade having a cutting-edge portion at one side end portion; a pair of plate-shaped members constituting a grip portion to be gripped by a user, the pair of plate-shaped members configured to be superimposed on each other so as to form an accommodation space for accommodating the cutting-edge portion therebetween and to sandwich a base end portion of the blade into a thickness direction at their front end regions, the pair of plate-shaped members configured to hold the blade capable of rotating in a first direction where the cutting-edge portion moves away from the accommodation space and a second direction where the cutting-edge portion moves toward an inside of the accommodation space, centering around a rotation axis passing through the base end portion of the blade; a stopper portion provided between the pair of plate-shaped members, and configured to abut on the base end portion of the blade when the blade rotates in the first direction and reaches a fixed position on a front end side of the grip portion and to stop the rotation of the blade in the first direction; a movement restricting portion disposed between the pair of plate-shaped members to be movable between a first position in a rotation region of the base end portion of the blade and a second position disposed away from the rotation region, the movement restricting portion configured, in a state where the blade is positioned at the fixed position, to move to the first position and to fit into a gap between the stopper portion and a locked portion provided at the base end portion of the blade, thereby restricting a movement of the blade in the second direction; and a manipulator portion provided so as to be partially exposed to an outside of the pair of plate-shaped members, the manipulator portion connected to the movement restricting portion so as to enable the user to manipulate the movement of the movement restricting portion.

According to the folding knife of the first aspect, the blade can be firmly fixed to the fixed position on the front end side of the grip portion by means of a simple configuration in which the movement restricting portion is moved and fitted into the gap between the stopper portion and the locked portion provided in the base end portion of the blade.

[Second Aspect] The folding knife according to the above-described first aspect may further include an elastic member configured to bias the movement restricting portion in a direction from the second position toward the first position.

According to the folding knife of the second aspect, since the movement of the movement restricting portion to the first position is assisted by the biasing force of the elastic member, the blade can be more easily fixed to the grip portion. Moreover, since the front end portion of the movement restricting portion can be more closely fitted into the gap between the stopper portion and the locked portion due to the biasing force of the elastic member, it is possible to further improve the fixation of the blade to the grip portion.

[Third Aspect] In the folding knife according to the above-described first or second aspect, the locked portion may be a first locked portion, and a second locked portion may be provided at the base end portion of the blade to lock the movement restricting portion which has moved toward the first position from the second position so that rotation of the blade in the first direction is restricted when the cutting-edge portion is accommodated in the accommodation space.

According to the folding knife of the third aspect, since the rotation of the blade is restricted by the locking of the blade of the front end portion of the movement restricting portion with respect to the second locked portion, the folding knife in the closed state can prevented from opening without the user's manipulation.

[Fourth Aspect] In the folding knife according to any one of the above-described first, second, and third aspects, the movement restricting portion may be configured to be movable between the first position and the second position which are aligned in a direction along a plate surface of the pair of plate-shaped members, and the front end portion of the movement restricting portion may have a tapered shape that gradually narrows in width in the direction from the second position toward the first position, and, when moving to the first position, may be inserted into the gap between the stopper portion and a locked portion provided at the base end portion of the blade.

According to the folding knife of the fourth aspect, since the front end portion of the movement restricting portion has the tapered shape, the front end portion can easily be inserted into the gap between the stopper portion and the locked portion of the base end portion of the blade. Moreover, the further the front end portion of the movement restricting portion is inserted, the more secure the blade can be fixed to the grip portion.

[Fifth Aspect] The folding knife according to the above-described fourth aspect may further include a cylindrical member disposed between the pair of plate-shaped members and configured to accommodate a rear end portion of the movement restricting portion, and the elastic member may be formed from a coil spring and may be accommodated inside the cylindrical member.

According to the folding knife of the fifth aspect, since the movement of the movement restricting portion is guided by the cylindrical member, the blade can be more smoothly fixed by the movement restricting portion. Moreover, since the coil spring is accommodated inside the cylindrical member, it is possible to prevent a foreign matter from entering the coil spring and inhibiting its elastic deformation.

[Sixth Aspect] In the folding knife according to the above-described fourth aspect, a through groove portion along a moving path of the movement restricting portion may be provided in at least one of the pair of plate-shaped members, the movement restricting portion may include a protruding portion on a side surface thereof, the protruding portion extending toward the outside of the pair of plate-shaped members through the through groove portion, and the elastic member may be disposed on the outside of the pair of plate-shaped members and may be configured to bias the movement restricting portion via the protruding portion in the direction from the second position toward the first position.

According to the folding knife of the sixth aspect, since the movement of the movement restricting portion is guided by the through groove portion, the movement restricting portion can be more smoothly moved. Moreover, since the elastic member is disposed on the outside of the pair of plate-shaped members, the region where the elastic member is disposed can be prevented from interfering with the accommodation space. Accordingly, it is possible to improve a degree of freedom in designing the size, the arrangement position, etc. of the elastic member.

[Seventh Aspect] In the folding knife according to the above-described sixth aspect, the through groove portion may be provided in each of the pair of plate-shaped members, the movement restricting portion may include, as the protruding portion, a first protruding portion and a second protruding portion, each extending outward through each of the through groove portion of the pair of plate-shaped members, and a first elastic member configured to bias the movement restricting portion through the first protruding portion and a second elastic member configured to bias the movement restricting portion through the second protruding portion may be provided on the outside of the pair of plate-shaped members, as the elastic member.

According to the folding knife of the seventh aspect, since the movement restricting portion can be biased in both sides in a thickness direction of the folding knife by the first elastic member and the second elastic member, the movement restricting portion can be moved in a more stable posture.

[Eighth Aspect] In the folding knife according to any one of the above-described second, third, fourth, fifth, sixth, and seventh aspects, an arcuate portion which is an arcuate-shaped outer peripheral edge portion centering around the rotation axis may be provided at the base end portion of the blade, and the locked portion may be formed from an edge portion of a recessed portion provided at an end of the arcuate portion.

According to the folding knife of the eighth aspect, the blade can be rotated in the state where the front end portion of the movement restricting portion is pressed against an end surface of the arcuate portion of the base end portion of the blade by the elastic member. In this state, when the blade is rotated in a direction of opening, and when the front end portion of the movement restricting portion reaches the recessed portion, the front end portion of the movement restricting portion is inserted into the recessed portion and locked with the edge portion of the recessed portion, thereby fixing the blade. Accordingly, when the folding knife is opened, the blade can be more easily and smoothly fixed.

[Ninth Aspect] In the folding knife according to the above-described second aspect or claim 3, the elastic member may disposed between the pair of plate-shaped members, the elastic member formed from a plate spring, the plate spring having a rear end side which is fixed and a front end side that is displaceable in a thickness direction due to elastic deformation, and the movement restricting portion may be provided at the front end of the plate spring and may move between the first position and the second position which are aligned in the thickness direction due to the elastic deformation of the plate spring.

According to the folding knife of the ninth aspect, the blade can be fixed to the grip portion by a simple configuration in which the movement restricting portion is moved from the second position to the first position due to the elastic deformation of the plate spring.

The technology disclosed herein can be realized in aspects other than folding knives, such as the opening and closing mechanism, locking mechanism, opening and closing method, and blade fixing method of a folding knife.

### BRIEF DESCRIPTION OF DRAWINGS

FIG. 1 A schematic top view illustrating a folding knife according to a first embodiment.

FIG. 2 A schematic side view illustrating the folding knife according to the first embodiment.

FIG. 3 A schematic top view illustrating an opening and closing operation of the folding knife according to the first embodiment.

FIG. 4 A schematic cross-sectional view of the folding knife according to the first embodiment.

FIG. 5 A schematic perspective view illustrating a movement restricting portion according to the first embodiment.

FIG. 6 A schematic diagram illustrating a state where a blade is released from a fixed state set by a locking mechanism.

FIG. 7 A schematic diagram illustrating a state of the blade that is being rotated toward an accommodation space.

FIG. 8 A schematic diagram illustrating a state of the locking mechanism in a closed state.

FIG. 9 A schematic cross-sectional view illustrating a configuration of a manipulator portion of a locking mechanism according to a second embodiment.

FIG. 10 A schematic top view illustrating a configuration of an elastic member of a locking mechanism according to a third embodiment.

FIG. 11 A schematic side view illustrating the configuration of the elastic member of the locking mechanism according to the third embodiment.

FIG. 12 A schematic cross-sectional view illustrating a configuration of the locking mechanism according to the third embodiment.

FIG. 13 A schematic top view illustrating an elastic member of a locking mechanism according to a fourth embodiment.

FIG. 14 A schematic top view illustrating an elastic member of a locking mechanism according to a fifth embodiment.

FIG. 15 A schematic perspective view illustrating a first alternative configuration example of the movement restricting portion.

FIG. 16 A schematic perspective view illustrating a second alternative configuration example of the movement restricting portion.

FIG. 17 A schematic top view illustrating a locking mechanism according to a sixth embodiment.

FIG. 18 A schematic side view illustrating the locking mechanism according to the sixth embodiment.

FIG. 19 A schematic side view illustrating a release of a fixed state of the locking mechanism according to the sixth embodiment.

FIG. 20 A schematic top view illustrating a state of the locking mechanism during a closing manipulation according to the sixth embodiment.

FIG. 21 A schematic top view diagram illustrating a state of the locking mechanism in a closed state according to the sixth embodiment.

### DESCRIPTION OF EMBODIMENTS

### 1. First Embodiment

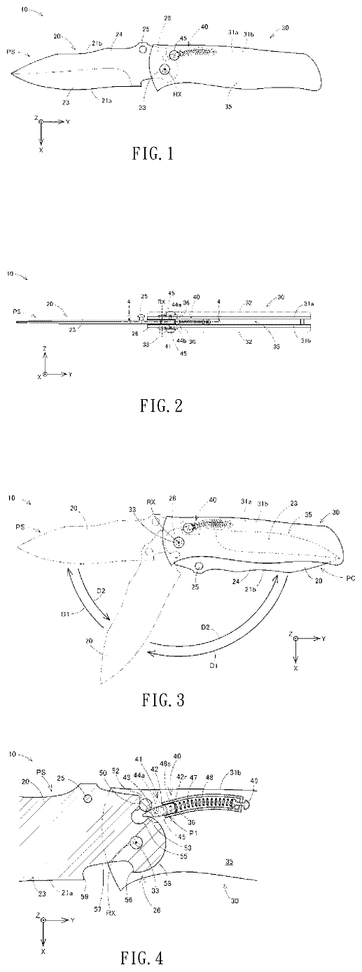

FIG. 1 is a schematic top view of a folding knife 10 according to the first embodiment, as viewed in a thickness direction. FIG. 2 is a schematic side view of the folding knife 10 according to the first embodiment, as viewed in a width direction. FIGS. 1 and 2 illustrate the folding knife 10 in an open state. FIG. 3 is a schematic top view illustrating the folding knife 10 in a closed state, illustrating a locus of a blade 20 when the folding knife 10 is opened and closed.

FIGS. 1 to 3 illustrate arrows, indicating an X direction, a Y direction, and a Z direction, which are three mutually orthogonal directions. The X direction, the Y direction, and the Z direction each indicate a direction with regard to the folding knife 10. The X direction is a non-longitudinal direction of the folding knife 10, corresponding to a width direction. The Y direction is a longitudinal direction of the folding knife 10, corresponding to a length direction. The Z direction corresponds to a thickness direction of the folding knife 10. The arrows indicating the X direction, the Y direction, and the Z direction are also illustrated in other referential drawings, as appropriate, so as to correspond to FIGS. 1 to 3.

The folding knife 10 includes a blade 20 including a cutting-edge portion 23, and a grip portion 30 to be gripped by a user. As illustrated in FIG. 3, the folding knife 10 can be changed from an “open state” in which the blade 20 and the grip portion 30 are aligned longitudinally to a “closed state” in which the blade 20 is folded with respect to the grip portion 30 and the cutting-edge portion 23 is accommodated inside an accommodation space 35 of the grip portion 30. In the folding knife 10 according to the first embodiment in a closed state, a second side end portion 21b of the blade 20 including a finger hook portion 25 is in a state of being exposed to the outside of the grip portion 30.

Refer to FIGS. 1 and 2. The cutting-edge portion 23 is provided at a first side end portion 21a, which is one end portion, in a width direction of the blade 20. The cutting-edge portion 23 is formed over from a front end of front of the blade 20 to just before a base end portion 26 in a length direction. The second side end portion 21b of the blade 20 positioned on an opposite side in a width direction to the first side end portion 21a forms a ridge portion 24 of which the thickness is larger than that of the cutting-edge portion 23.

The blade 20 is provided with the finger hook portion 25 on which the user can hook its own finger in order to rotate the blade 20. The finger hook portion 25 is provided at a position close to the grip portion 30 of the blade 20. The finger hook portion 25 is formed, for example, from a knob-shaped member attached to the ridge portion 24 so as to protrude in the thickness direction. In an alternative embodiment, the finger hook portion 25 may be formed, for example, from a through-hole passing through the blade 20 in the thickness direction, instead of the knob-shaped member. Alternatively, the finger hook portion 25 may be omitted.

Refer to FIG. 2. The folding knife 10 includes a pair of plate-shaped members 31a, 31b to form the grip portion 30. The pair of plate-shaped members 31a, 31b have an outer peripheral contour shape corresponding to each other's shape and are superimposed on each other in the thickness direction to form the grip portion 30.

Exterior members 32 that constitute the grip portion 30 together with the pair of plate-shaped members 31a, 31b are respectively attached to outer surfaces of the first plate-shaped member 31a and the second plate-shaped member 31b. In FIG. 2, the exterior member 32 is illustrated by the dash-dot line for convenience. In addition, except for FIG. 2, the exterior member 32 is omitted from the illustration for convenience.

A slit-shaped gap is formed between the first plate-shaped member 31a and the second plate-shaped member 31b. A part of the gap between the first plate-shaped member 31a and the second plate-shaped member 31b forms the accommodation space 35 for accommodating the cutting-edge portion 23.

The base end portion 26 of the blade 20 is sandwiched between a front end region of the first plate-shaped member 31a and a front end region of the second plate-shaped member 31b in the thickness direction. The first plate-shaped member 31a, the second plate-shaped member 31b, and the base end portion 26 of the blade 20 are connected with a connecting shaft member 33 which passes through and fastens them in the thickness direction. Consequently, the blade 20 is held in a rotatable state with respect to the pair of plate-shaped members 31a, 31b.

A central shaft of the connecting shaft member 33 corresponds to the rotation axis RX of the blade 20. As illustrated in FIG. 3, the blade 20 can be rotated centering around the rotation axis RX passing through the base end portion 26 of the blade 20 in a first direction D1 where the cutting-edge portion 23 moves away from the accommodation space 35 and a second direction D2 where the cutting-edge portion 23 moves to the accommodation space 35.

The grip portion 30 is provided with a locking mechanism 40. When the folding knife 10 is in the open state, the blade 20 is fixed to a fixed position PS on the front end side of the grip portion 30 illustrated in FIG. 1 by the locking mechanism 40. In contrast, when the folding knife 10 is in the closed state, the cutting-edge portion 23 is accommodated in the accommodation space 35 in the grip portion 30, and the blade 20 is fixed to an accommodated position PC illustrated in FIG. 3 by the locking mechanism 40. By manipulating the locking mechanism 40, the user can release the fixed state where the rotation of the blade 20 is restricted by the locking mechanism 40.

The locking mechanism 40 and its surrounding configuration will be described below with reference to FIGS. 4 to 8.

FIG. 4 is a schematic cross-sectional view of surroundings of the locking mechanism 40 of the folding knife 10 taken in the line 4-4 illustrated in FIG. 2. FIG. 4 illustrates the folding knife 10 in the open state, in a state where the position of the blade 20 is being fixed by the locking mechanism 40.

The locking mechanism 40 according to the first embodiment includes a movement restricting portion 41, an elastic member 47, and a cylindrical member 48. The movement restricting portion 41 is disposed between the pair of plate-shaped members 31a, 31b so as to be movable between a first position P1 (FIG. 4) and a second position P2 (FIG. 6). In the first embodiment, the first position P1 and the second position P2 are aligned in a direction along a plate surface of the pair of plate-shaped members 31a, 31b.

FIG. 4 illustrates the movement restricting portion 41 when it is disposed at the first position P1. A first position P1 is within a rotation region of the base end portion 26 of the blade 20. The “rotation region of the base end portion 26 of the blade 20” means a region where the base end portion 26 passes through when the blade 20 is rotated centering around the rotation axis RX. When the movement restricting portion 41 is positioned at the first position P1, at least the front end portion 43 thereof is disposed within the rotation region of the base end portion 26 of the blade 20.

FIG. 6, which will be referred to later, illustrates the movement restricting portion 41 when it is disposed at the second position P2. The second position P2 is positioned on a rear end side of the first position P1 so as to be away from the rotation region of the base end portion 26 of the blade 20. At the second position P2, the entire movement restricting portion 41 is away from the rotation region of the base end portion 26 of the blade 20.

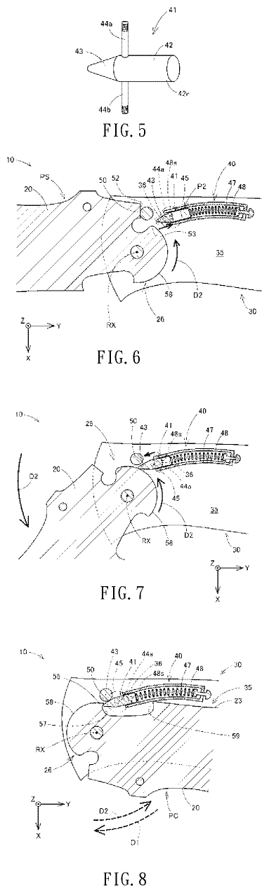

FIG. 5 is a schematic perspective illustrating a configuration example of the movement restricting portion 41 according to the first embodiment. In the first embodiment, the movement restricting portion 41 is formed from a straight rod-shaped member having a substantially circular cross section. The movement restricting portion 41 includes a main body portion 42 having a substantially cylindrical shape, and a front end portion 43 having a wedge shape, i.e., a tapered shape that gradually narrows in width toward the front end side. In the first embodiment, the front end portion 43 of the movement restricting portion 41 has a tapered shape that gradually decreases in diameter toward the front end side.

A pair of shaft-shaped protruding portions 44a, 44b respectively extending in opposite directions along the thickness direction are provided on a side surface of the main body portion 42 of the movement restricting portion 41. As illustrated in FIG. 2, the first protruding portion 44a is disposed so as to extend to the outside of the grip portion 30 through the through groove portion 36 provided in the first plate-shaped member 31a, and a second protruding portion 44b is disposed so as to extend to the outside of the grip portion 30 through the through groove portion 36 provided in the second plate-shaped member 31b.

The through groove portion 36 of the pair of plate-shaped members 31a, 31b is formed along a moving path of the movement restricting portion 41, as illustrated by the dashed line in FIG. 4. As illustrated in FIG. 2, a manipulator portion 45 for user's manipulation is attached to an end portion of each protruding portion 44 of the movement restricting portion 41 extending to the outside of the grip portion 30 through the through groove portion 36. As illustrated in FIG. 5, a thread groove for threadably engaging the manipulator portion 45 is formed on the end portion of each protruding portion 44.

In FIG. 4, the position of the first protruding portion 44a and the manipulator portion 45 is illustrated by the dash-dot line. The user can move the movement restricting portion 41 in the grip portion 30 along the through groove portion 36 by hooking a finger and moving the manipulator portion 45.

As illustrated in FIG. 4, the cylindrical member 48 is disposed on the rear end side of the movement restricting portion 41. In the first embodiment, the cylindrical member 48 is disposed along the side end portion, at a position near the side end portion of the grip portion 30 in a width direction.

The cylindrical member 48 has an inner diameter larger than the diameter of the main body portion 42 of the movement restricting portion 41. A rear end portion 42r of the movement restricting portion 41 is inserted into the cylindrical member 48. When the movement regulating portion 41 moves between the first position P1 and the second position P2, the rear end portion 42r of the movement regulating portion 41 moves inside the cylindrical member 48. The cylindrical member 48 has a function of guiding the movement of the movement restricting portion 41.

In the present embodiment, a guide slit 48s is provided at an entrance on the front end side of the cylindrical member 48, into which the pair of protruding portions 44a, 44b of the movement restricting portion 41 are inserted. In a vicinity of the second position P2, the movement restricting portion 41 is guided by the guide slit 48s and can move stably. In an alternative embodiment, the guide slit 48s may be omitted by shortening the cylindrical member 48.

The elastic member 47 formed from the coil spring is accommodated in the cylindrical member 48. The rear end portion 42r of the movement restricting portion 41 is biased by the elastic member 47 in a direction from the second position P2 toward the first position P1. By accommodating the coil spring in the cylindrical member 48, it is possible to prevent a foreign matter from entering the gap in the coil spring and impeding the elastic deformation of the coil spring.

In the first embodiment, the front end side of the cylindrical member 48 has a curved shape toward a direction of the rotation axis RX of the blade 20. The elastic member 47 accommodated in the cylindrical member 48 is similarly disposed in a curved state. Since the curved cylindrical member 48 is used in this manner, even when the length of the elastic member 47 is increased in order to obtain biasing force desired on the movement restricting portion 41, it is possible to easily ensure the disposition region of the elastic member 47 within a limited space in the grip portion 30. Moreover, the space inside the grip portion 30 can be used more efficiently, and the grip portion 30 can be easily made smaller while ensuring the disposition region the elastic member 47 inside the grip portion 30.

An adjustment screw 49 is provided at the rear end portion of the cylindrical member 48. The adjustment screw 49 penetrates into the cylindrical member 48, and the front end thereof is in contact with the rear end portion of the elastic member 47. The user can adjust a depth of the adjustment screw 49 inserted into the cylindrical member 48 using, for example, a screwdriver etc. which can be inserted between the pair of plate-shaped members 31a, 31b. Consequently, it is possible to adjust an expansion and contraction state of the elastic member 47 within the cylindrical member 48, and to adjust the biasing force applied from the elastic member 47 to the movement restricting portion 41.

A stopper portion 50 is provided between the pair of plate-shaped members 31a, 31b. In the first embodiment, the stopper portion 50 is formed from a cylindrical member disposed so as to penetrate the gap between the pair of plate-shaped members 31a, 31b in the thickness direction. When the blade 20 rotates in the first direction D1 and reaches the fixed position PS of the front end side of the grip portion 30, the stopper portion 50 abuts against the base end portion 26 of the blade 20 to stop the movement to the first direction D1 of the blade 20. An abutting surface 52 abutting against the stopper portion 50 is provided on an outer peripheral end surface of the base end portion 26 of the blade 20. The abutting surface 52 is preferably provided so as to be orthogonal to the direction of rotation of the blade 20.

A first locked portion 53 is provided on the base end portion 26 of the blade 20 at a position adjacent to the abutting surface 52, which is a position closer to the rotation axis RX than the abutting surface 52. A first recessed portion 55 recessed toward the front end side is provided on the base end portion 26 of the blade 20 at a position adjacent to the abutting surface 52. The first locked portion 53 is formed from an edge portion of the first recessed portion 55 facing the abutting surface 52 with the first recessed portion 55 interposed therebetween.

As illustrated in FIG. 4, when the abutting surface 52 of the base end portion 26 of the blade 20 abuts against the stopper portion 50, a gap in communication with the first recessed portion 55 is formed between the stopper portion 50 and the first locked portion 53. When the folding knife 10 is turned to the open state, the front end portion 43 of the movement restricting portion 41 is inserted into the gap, thereby restricting the rotation of the blade 20 and fixing the blade 20 to the grip portion 30.

In the first embodiment, since the front end portion 43 of the movement restricting portion 41 has the tapered wedge shape and therefore can easily be inserted deeply into the gap between the stopper portion 50 and the first locked portion 53. Moreover, the further the front end portion 43 of the movement restricting portion 41 is inserted deeply into the gap, the more securely the blade 20 can be fixed to the grip portion 30.

In the first embodiment, the movement restricting portion 41 is biased by the elastic member 47 toward the depth of the gap between the stopper portion 50 and the first locked portion 53. Consequently, since the movement of the movement restricting portion 41 to the first position P1 is assisted, making it easier to move the movement restricting portion 41 to the first position P1. Moreover, the biasing force of the elastic member 47 acts in a direction in which the front end portion 43 of the movement restricting portion 41 is inserted into the gap between the stopper portion 50 and the first locked portion 53, thereby further improving the fixation of the blade 20 to the grip portion 30. Moreover, the movement restricting portion 41 is prevented from moving to the rear end side, without the user's manipulation, which may cause the blade 20 to be released from the fixed state.

In addition to the above-described first locked portion 53, the base end portion 26 of the blade 20 is provided with a second locked portion 56 to which the front end portion 43 of the movement restricting portion 41 is locked when the folding knife 10 is turned to the closed state. The second locked portion 56 is formed from the edge portion on the rotation axis RX side of the second recessed portion 57 provided at the second side end portion 21b side of the blade 20.

The base end portion 26 of the blade 20 is provided with an arcuate portion 58 formed from an arcuate-shaped outer peripheral edge portion centering around the rotation axis RX of the blade 20. The arcuate portion 58 is provided at a position adjacent to the first recessed portion 55. In the present embodiment, the arcuate portion 58 is provided between the first recessed portion 55 and the second recessed portion 57, and the above-described first locked portion 53 and second locked portion 56 form the end portion of the arcuate portion 58. The radius of the arcuate portion 58 is smaller than a distance between the rotation axis RX and the stopper portion 50. Consequently, the arcuate portion 58 is prevented from interfering with stopper portion 50 when the blade 20 is rotated centering around the rotation axis RX.

Hereinafter, a function of the second locked portion 56 and the arcuate portion 58 will be described, while describing the manipulation when the folding knife 10 is turned from the open state to the closed state, with reference to FIGS. 6, 7, and 8 in this order. A state of surroundings of the locking mechanism 40 of the folding knife 10 when being turned from the open state to the closed state is illustrated FIGS. 6 to 8 using schematic cross-sectional view similar to FIG. 4.

FIG. 6 schematically illustrates the folding knife 10 in the open state, in a state where the fixed state of the blade 20 by the locking mechanism 40 is released. The user can move the movement restricting portion 41 in the direction of the second position P2 by moving the manipulator portion 45 toward the rear end side of the grip portion 30. When the movement restricting portion 41 is positioned at the second position P2, the front end portion 43 of the movement restricting portion 41 is away from the rotation region of the base end portion 26 of the blade 20 and is disposed at a position where no interference with the base end portion 26 occurs. This allows the blade 20 to rotate in the second direction D2.

FIG. 7 schematically illustrates a state of the blade 20 that is being rotated in the second direction D2 toward the accommodation space 35 of the grip portion 30. After starting to rotate the blade 20 from the fixed position PS, the user may release an external force that has been applied to the manipulator portion 45. When the user removes its own finger from the manipulator portion 45 to release the external force on the manipulator portion 45, the movement restricting portion 41 moves toward the first position P1, due to the biasing force of the elastic member 47, and the front end portion 43 comes into contact with the end surface of the arcuate portion 58. Since the arcuate portion 58 is formed at the base end portion 26, the blade 20 can continue to rotate smoothly even when the front end portion 43 of the movement restricting portion 41 is pressed against the base end portion 26 by the elastic member 47.

FIG. 8 schematically illustrates the folding knife 10 in the closed state where the cutting-edge portion 23 is accommodated in the accommodation space 35 and the blade 20 is fixed by the locking mechanism 40. When the blade 20 is rotated in the second direction D2 and the blade 20 reaches the accommodated position PC, the front end portion 43 of the movement restricting portion 41 is inserted into the second recessed portion 57 and becomes locked with respect to the second locked portion 56, restricting the blade 20 from rotating in the first direction D1 in which the cutting-edge portion 23 moves away from the accommodation space 35.

The blade 20 is provided with an abutting portion 59 abutting against the side surface of the cylindrical member 48 in the locking mechanism 40 when it reaches the accommodated position PC. In the first embodiment, the abutting portion 59 is formed from the edge portion of the second recessed portion 57 on a side opposite to the second locked portion 56. When the abutting portion 59 abuts against the side surface of the cylindrical member 48, the blade 20 is restricted from further rotating from the accommodated position PC to the second direction D2.

In order to return the folding knife 10 from the closed state illustrated in FIG. 8 to the open state illustrated in FIG. 4, the user merely hooks its own finger on the finger hook portion 25 of the blade 20 and performs the manipulation of rotating the blade 20 in the first direction D1. The folding knife 10 according to the first embodiment is configured so that, when the user performs such a manipulation, the locked state between the front end portion 43 of the movement restricting portion 41 and the second locked portion 56 illustrated in FIG. 8 is released. Specifically, the biasing force of the elastic member 47 and the contact area between the front end portion 43 of the movement restricting portion 41 and the second locked portion 56 in the locked state are adjusted. This facilitates the manipulation to open the folding knife 10 in the closed state.

When the folding knife 10 is opened, the movement restricting portion 41 moves toward the first position P1 due to the elastic force of the elastic member 47, and the front end portion 43 thereof is in contact with the end surface of the arcuate portion 58 of the blade 20 in the same manner as the state illustrated in FIG. 7. When the blade 20 is further rotated in the first direction D1 in this state and then the blade 20 reaches the fixed position PS, the front end portion 43 of the movement restricting portion 41 automatically fits into the gap between the stopper portion 50 and the first locked portion 53 due to the biasing force of the elastic member 47, and the blade 20 is fixed.

As described above, according to the folding knife 10 of the first embodiment, the blade 20 can be fixed to the fixed position PS with a simple configuration in which the front end portion 43 of the movement restricting portion 41 is inserted into the gap between the stopper portion 50 of the grip portion 30 and the first locked portion 53 of the base end portion 26 of the blade 20. Moreover, according to the folding knife 10 of the first embodiment, the fixation of the blade 20 to the grip portion 30 in the open state and manipulability when the folding knife 10 is opened are further improved by the biasing force of the elastic member 47 applied to the movement restricting portion 41.

### 2. Second Embodiment

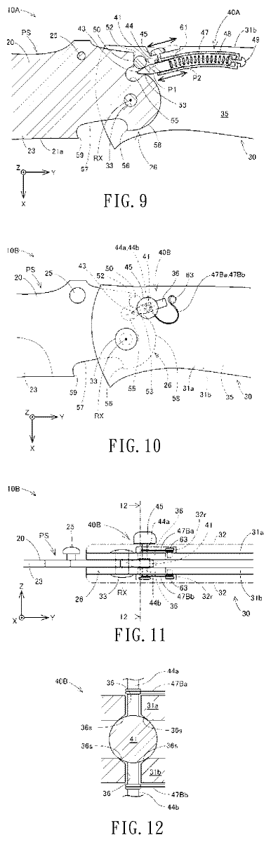

FIG. 9 is a schematic cross-sectional view illustrating a configuration of a locking mechanism 40A provided in a folding knife 10A according to a second embodiment. FIG. 9 illustrates a state where the movement restricting portion 41 is in the first position P1 and illustrates a state when the movement restricting portion 41 moves to the second position P2 by the dash-dot line.

The configuration of the folding knife 10A according to the second embodiment is substantially the same as the configuration of the folding knife 10 according to the first embodiment except for being provided with a locking mechanism 40A according to the second embodiment. The configuration of the locking mechanism 40A according to the second embodiment is substantially the same as that of the locking mechanism 40 according to the first embodiment except for that a position of forming the manipulator portion 45 is different.

In the second embodiment, the movement restricting portion 41 includes the protruding portion 44 on the side surface thereof extending toward the side end portion of the grip portion 30 through a slit 61 provided on the side surface of the cylindrical member 48. The manipulator portion 45 is provided at the end portion of the protruding portion 44 extending outward from the side surface portion of the grip portion 30.

According to the folding knife 10A of the second embodiment, the user can move the movement restricting portion 41 between the first position P1 and the second position P2 by moving the manipulator portion 45 in the longitudinal direction provided on the side surface portion of the grip portion 30. In addition, according to the folding knife 10A of the second embodiment, it is possible to produce various advantageous effects similar to those described in the first embodiment.

### 3. Third Embodiment

FIG. 10 is a schematic top view of a region of a folding knife 10B according to a third embodiment where a locking mechanism 40B is provided, as viewed in the thickness direction. FIG. 11 is a schematic side view of the region of the folding knife 10B that is corresponding to FIG. 10, as viewed in the width direction. In FIG. 11, the exterior member 32 disposed outside each of the pair of plate-shaped members 31a, 31b is illustrated by the dash-dot line. In FIG. 10, the illustration of the exterior member 32 is omitted.

The configuration of the folding knife 10B according to the third embodiment is substantially the same as the configuration of the folding knife 10 according to the first embodiment except for being provided with a locking mechanism 40B according to the third embodiment. The configuration of the locking mechanism 40B according to the third embodiment is substantially the same as that of the locking mechanism 40 according to the first embodiment except for points described below.

The locking mechanism 40B according to the third embodiment does not include the cylindrical member 48, but includes a pair of elastic members 47Ba, 47Bb. In the third embodiment, the manipulator portion 45 of the movement restricting portion 41 is provided only on the end portion of the first protruding portion 44a of the movement restricting portion 41. In an alternative embodiment, at least one of the pair of elastic members 47Ba, 47Bb may be omitted. Although illustration and detailed description are omitted, it is preferable that, in the folding knife 10B according to the third embodiment, a structure against which the abutting portion 59 of the blade 20 abuts is provided in the grip portion 30, instead of the cylindrical member 48.

As illustrated in FIG. 10, the first elastic member 47Ba and the second elastic member 47Bb have a configuration obtained by elastically deforming and bending an elastic wire member. As illustrated in FIG. 11, the first elastic member 47Ba is disposed on the outer plate surface of the first plate-shaped member 31a, and the second elastic member 47Bb is disposed on the outer plate surface of the second plate-shaped member 31b. A recessed portion for forming an accommodation chamber 32r in which each elastic member 47Ba, 47Bb is accommodated is formed in the exterior member 32.

The first elastic member 47Ba has one end portion that is wound around the first protruding portion 44a of the movement restricting portion 41, and the other end portion that is wound around a convex fixed portion 63 provided on the plate surface of the first plate-shaped member 31a. The first elastic member 47Ba biases the movement restricting portion 41 via the first protruding portion 44a.

The second elastic member 47Bb has one end portion that is wound around the second protruding portion 44b of the movement restricting portion 41, and the other end portion that is wound around a convex fixed portion 63 provided on the plate surface of the second plate-shaped member 31b. The second elastic member 47Bb biases the movement restricting portion 41 via the second protruding portion 44b.

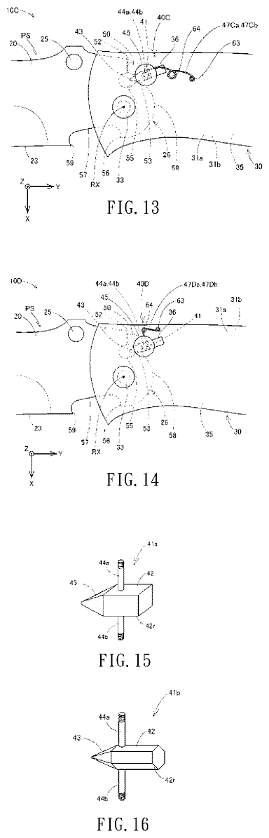

FIG. 12 is a schematic cross-sectional view of a locking mechanism 40B taken in the line 12-12 illustrated in FIG. 11. Inclined surfaces 36s formed by cutting corner portions facing the side surface of the movement restricting portion 41 are formed on the through groove portion 36 provided on each of the pair of plate-shaped members 31a, 31b. Consequently, since a movement restricting portion 41 is in a state of being surrounded and held by four inclined surfaces 36s and therefore can move in a stable posture between the first position P1 and the second positions P2. The inclined surfaces 36s may be omitted in an alternative embodiment.

According to the folding knife 10B of the third embodiment, since the pair of elastic members 47Ba, 47Bb is disposed outside the pair of plate-shaped members 31a, 31b, the disposition regions of the pair of elastic members 47Ba, 47Bb do not interfere with the accommodation space 35 of the blade 20. Accordingly, it is possible to improve the degree of freedom in designing the size and arrangement position of the elastic members 47Ba, 47Bb. According to the elastic members 47Ba, 47Bb of the third embodiment, it is possible to reduce the area occupied in the length direction of the grip portion 30. In addition, according to the folding knife 10B of the third embodiment, it is possible to produce various advantageous effects similar to those described in the first embodiment.

### 4. Fourth Embodiment

FIG. 13 is a schematic top view diagram of a region of a folding knife 10C according to a fourth embodiment where a locking mechanism 40C is provided, as viewed in the thickness direction. The configuration of the folding knife 10C according to the fourth embodiment is substantially the same as the folding knife 10B according to the third embodiment except for being provided with a locking mechanism 40C in which a configuration of a pair of elastic members 47Ca, 47Cb is different therefrom. The configuration of the pair of elastic members 47Ca, 47Cb according to the fourth embodiment is substantially the same as that of the elastic members 47Ba, 47Bb according to the third embodiment except that a center portion thereof is wound around a central fixed portion 64 provided on each plate surface of the pair of plate-shaped members 31a, 31b.

According to the pair of elastic members 47Ca, 47Cb according to the fourth embodiment, it is possible to reduce an installing area within the grip portion 30, ensuring the biasing force applied to the movement restricting portion 41. In addition, according to the folding knife 10C of the fourth embodiment, it is possible to produce various advantageous effects similar to those described in each embodiment.

### 5. Fifth Embodiment

FIG. 14 is a schematic top view of a region of a folding knife 10D according to a fifth embodiment where a locking mechanism 40D is provided, as viewed in the thickness direction. The configuration of the folding knife 10D according to the fourth embodiment is substantially the same as that of the folding knife 10B according to the third embodiment except for being provided with a locking mechanism 40D in which a configuration of a pair of elastic members 47Da, 47Db is different therefrom. The elastic members 47Da, 47Db according to the fifth embodiment are formed from a torsion spring, and are provided closer to the side end portion side of the grip portion 30 than the movement restricting portion 41. At least one of the elastic members 47Da, 47Db may be disposed in the space between the pair of plate-shaped members 31a, 31b. In addition, also in the folding knife 10D according to the fifth embodiment, it is possible to produce various advantageous effects similar to those described in each embodiment.

### 6. Examples of Other Configuration of Movement Restricting Portion

FIGS. 15 and 16 are schematic perspective views respectively illustrating movement restricting portions 41a, 41b as alternative configuration examples. In the movement restricting portion 41a of a first configuration example illustrated in FIG. 15, the main body portion 42 has a square prism shape. In contrast, in the movement restricting portion 41b of a second configuration example illustrated in FIG. 16, the main body portion 42 has a polygonal prism shape. The movement restricting portions 41a, 41b can be applied to the above-described first, second, third, fourth, and fifth embodiments. In addition, also in the movement restricting portions 41a, 41b, it is possible to produce various advantageous effects similar to those described in each embodiment.

### 7. Sixth Embodiment

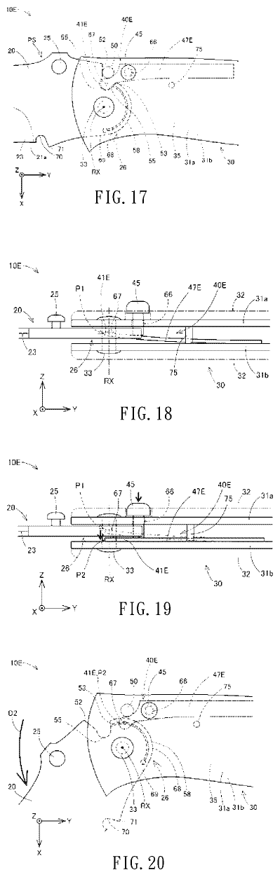

FIG. 17 is a schematic top view of a folding knife 10E according to a sixth embodiment, as viewed in the thickness direction. FIGS. 18 and 19 are schematic side views of a region of a folding knife 10E according to the sixth embodiment where a locking mechanism 40E is provided, as viewed in the width direction. FIG. 18 illustrates a state where the elastic member 47E is not elastically deformed, and FIG. 19 illustrates a state where the elastic member 47E is elastically deformed.

The configuration of the folding knife 10E according to the sixth embodiment is substantially the same as that of the folding knife 10 according to the first embodiment except for that a locking mechanism 40E having a configuration different therefrom is provided, and the configuration of the base end portion 26 of the blade 20 is different therefrom. The locking mechanism 40E according to the sixth embodiment includes the elastic member 47E formed from a plate spring. The elastic member 47E is disposed along the side end portion of the grip portion 30 between the pair of plate-shaped members 31a, 31b.

A region on the rear end side of the elastic member 47E is fixed to the second plate-shaped member 31b, and a region on the front end side is disposed in a state of being floated from the second plate-shaped member 31b when no external force is applied, as illustrated in FIG. 18. When the external force is applied the elastic member 47E, as illustrated in FIG. 19, the elastic member 47E is elastically deformed and the region on the front end side is displaced in the thickness direction.

A movement restricting portion 41E of the locking mechanism 40E according to the sixth embodiment is provided on a region on the front end side of the elastic member 47E. The movement restricting portion 41E moves, due to elastic deformation of the elastic member 47E, between the first position P1 and the second position P2 aligned in the thickness direction. The first position P1 is a position within the rotation region of the base end portion 26 of the blade 20, and the second position P2 is a position away from the rotation region of the base end portion 26 of the blade 20 in the thickness direction. The movement restricting portion 41E is biased in a direction from the second position P2 toward the first position, when it is located closer to the second position P2 side than the first position P1.

When the blade 20 is positioned at the fixed position PS and the movement restricting portion 41E is positioned at the first position P1, as illustrated in FIG. 17, it is inserted into the first recessed portion 55 of the base end portion 26 of the blade 20, and the base end portion fits into the gap between the stopper portion 50 and the first locked portion 53. Consequently, the blade 20 is restricted from rotating in the second direction D2 centering around the rotation axis RX and therefore is fixed to the grip portion 30.

A manipulator portion 45 that can be pressed in the thickness direction by the user is provided on the front end side of the elastic member 47E. The manipulator portion 45 protrudes outward through the through-hole 66 provided in the first plate-shaped member 31a. When the user presses the manipulator portion 45 in the thickness direction, the elastic member 47E is elastically deformed, and the movement restricting portion 41 moves to the second position P2, as illustrated in FIG. 19. Consequently, the movement restricting portion 41E moves away from the base end portion 26 of the blade 20, and the fixed state of the blade 20 is released.

FIG. 20 is a schematic top view illustrating a state of the blade 20 that is being rotated to the second direction D2 when the movement restricting portion 41E is positioned at the second position P2. A hemispherical protrusion 67 is provided at the front end of the movement restricting portion 41E. Moreover, in the sixth embodiment, a groove portion 68 forming an arc centering around the rotation axis RX is provided on the surface of the base end portion 26 of the blade 20. One end portion of the groove portion 68 is connected to the first recessed portion 55. A hemispherical recessed portion 69 into which the protrusion 67 of the movement restricting portion 41E can be fitted is provided on the other end portion of the groove portion 68 positioned on the opposite side with the rotation axis RX interposed therebetween. While the blade 20 is being rotated, the protrusion 67 slides on the base end portion 26 along the groove portion 68 in a state where a part of the protrusion 67 is fitted into the groove portion 68 on the surface of the base end portion 26. The groove portion 68 may be omitted in an alternative embodiment.

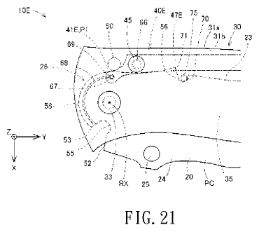

FIG. 21 is a schematic top view illustrating the locking mechanism 40E of the folding knife 10E in the closed state where the cutting-edge portion 23 of the blade 20 is accommodated in the accommodation space 35. When the blade 20 reaches the accommodated position PC, the protrusion 67 of the movement restricting portion 41E fits into the recessed portion 69 of the base end portion 26 of the blade 20.

A second recessed portion 70 is formed on the base end portion 26 of the blade 20 at a position adjacent to the cutting-edge portion 23. Moreover, a columnar portion 75 is provided in a region before the accommodation space 35 inside the grip portion 30 so as to pass through the pair of plate-shaped members 31a, 31b. The columnar portion 75 is provided on the side of the elastic member 47E.

When the blade 20 reaches the accommodated position PC, as illustrated in FIG. 21, the columnar portion 75 reaches into the second recessed portion 70 of the base end portion 26 of the blade 20 and abuts against the end surface of the inner peripheral edge of the second recessed portion 70. Consequently, the further rotation of the blade 20 in the second direction D2 is restricted. An edge portion 71 on the rotation axis RX side of the second recessed portion 70 protrudes laterally, and, when the blade 20 is positioned at the accommodated position PC, is positioned on the elastic member 47E.

It is configured so that the fitted state of the protrusion 67 into the recessed portion 69 when it is in the closed state is released when the user performs a manipulation of hooking its own finger on the finger hook portion 25 and rotating the blade 20 in a direction where it is opened. Specifically, the size of the protrusion 67 with respect to the recessed portion 69 and the elastic force of the elastic member 47E are adjusted so that the fitted state can be released. This allows the user to more easily open the folding knife 10E in the closed state.

According to the folding knife 10E of the sixth embodiment, the blade 20 ca be fixed to the grip portion 30 by the simple configuration in which the movement restricting portion 41E is moved due to elastic deformation of the elastic member 47E formed from the plate spring. In addition, according to the folding knife 10E of the sixth embodiment, it is possible to produce various advantageous effects similar to those described in each embodiment.

### 8. Alternative Embodiments

The technology disclosed herein is not limited to the configurations of the above-described embodiments and can be modified, for example, as follows. Similar to the above-described embodiments, the alternative embodiments described below are all considered as examples of aspects for implementing the technology disclosed herein.

### (1) Alternative Embodiment 1

In each of above-described embodiments, a configuration may be adopted in which the locking mechanisms 40, 40A, 40B, 40C, 40D, and 40E are configured so that the movement restricting portion 41 moves only when the user performs manipulation through the manipulator portion 45, without using the biasing force from the elastic member. Moreover, in each of the above embodiments, a configuration may be adopted in which the locking mechanisms 40, 40A, 40B, 40C, 40D, and 40E are configured so that the movement restricting portion 41 is biased by the elastic force from the elastically deformable material such as rubber, not limited to metal. Moreover, a configuration may be adopted in which the movement restricting portion 41 is biased by a magnetic force.

### (2) Alternative Embodiment 2

The configuration of the movement restricting portions 41, 41a, 41b, 41E or the base end portion 26 of the blade 20 is not limited to the configuration described in each of above-described embodiment. For example, the front end portion 43 of the movement restricting portion 41 may have a configuration in which only the width decreases toward the front end but the thickness is constant. The movement restricting portion 41 may have a configuration in which a recess is formed on the side surface into which the stopper portion 50 or the first locked portion 53 is fitted, instead of the front end portion 43 having the tapered shape. The movement restricting portion 41 may not have a region corresponding to the main body portion 42, but may be formed from only a region corresponding to the front end portion 43. Moreover, the base end portion 26 of the blade 20 may not include the arcuate portion 58 and the second recessed portion 57.

### (3) Alternative Embodiment 3

In the above-described first and second embodiments, the adjustment screw 49 may be omitted and the cylindrical member 48 may be omitted. Moreover, the cylindrical member 48 may not have the curved shape.

### (4) Alternative Embodiment 4

In the third embodiment, any one of the pair of protruding portions 44a, 44b of the movement restricting portion 41 and the pair of elastic members 47Ba, 47Bb may be omitted. The same applies to the pair of elastic members 47Ca, 47Cb in the fourth embodiment and the pair of elastic members 47Da, 47 Db in the fifth embodiment.

### (5) Alternative Embodiment 5

The configurations of the locking mechanisms 40, 40A, 40B, 40C, 40D, 40E described in the above-described embodiments and the above-described alternative embodiments may be applied to various devices having folding mechanisms other than the folding knife. For example, the present invention may be applied to devices having a folding mechanism, e.g., eating utensils such as spoons and forks, stationery such as writing implements and rulers, and cosmetic implements such as combs.

### REFERENCE SIGNS LIST

10, 10A, 10B, 10C, 10D, 10E: Folding knife; 20: Blade; 21a: First side end portion; 21b: Second side end portion; 23: Cutting-edge portion; 24: Ridge portion; 25: Finger hook portion; 26: Base end portion; 30: Grip portion; 31a, 31b: Pair of plate-shaped members; 32: Exterior member; 32r: Accommodation chamber; 33: Connecting shaft member; 35: Accommodation space; 36: Through groove portion; 36s: Inclined surface; 40, 40A, 40B, 40C, 40D, 40E: Locking mechanism; 41, 41a, 41b, 41E: Movement restricting portion; 42: Main body portion; 42r: Rear end portion; 43: Front end portion; 44, 44a, 44b: Protruding portion; 45: Manipulator portion; 47, 47Ba, 47Bb, 47Ca, 47Cb, 47Da, 47Db, and 47E: Elastic member; 48: Cylindrical member; 48s: Guide slit; 49: Adjustment screw; 50: Stopper portion; 52: Abutting surface; 53: First locked portion 55: First recessed portion; 56: Second locked portion; 57: Second recessed portion; 58: Arcuate portion; 59: Abutting portion; 61: Slit; 63: Fixed portion; 64: Central fixed portion; 66: Through-hole; 67: Protrusion; 68: Groove portion; 69: Recessed portion; 70: Second recessed portion; 71: Edge portion; 75: Columnar portion; D1: First direction; D2: Second direction; P1: First position; P2: Second position; PC: Accommodated position; PS: Fixed position; and RX: Rotation axis.

1. A folding knife comprising:
a blade having a cutting-edge portion at one side end portion;
a pair of plate-shaped members constituting a grip portion to be gripped by a user, the pair of plate-shaped members configured to be superimposed on each other so as to form an accommodation space for accommodating the cutting-edge portion therebetween and to sandwich a base end portion of the blade into a thickness direction at their front end regions, the pair of plate-shaped members configured to hold the blade capable of rotating in a first direction where the cutting-edge portion moves away from the accommodation space and a second direction where the cutting-edge portion moves toward an inside of the accommodation space, centering around a rotation axis passing through the base end portion of the blade;
a stopper portion provided between the pair of plate-shaped members, and configured to abut on the base end portion of the blade when the blade rotates in the first direction and reaches a fixed position on a front end side of the grip portion and to stop the rotation of the blade in the first direction;
a movement restricting portion disposed between the pair of plate-shaped members to be movable between a first position in a rotation region of the base end portion of the blade and a second position disposed away from the rotation region, the movement restricting portion configured, in a state where the blade is positioned at the fixed position, to move to the first position and to fit into a gap between the stopper portion and a locked portion provided at the base end portion of the blade, thereby restricting a movement of the blade in the second direction; and
a manipulator portion provided so as to be partially exposed to an outside of the pair of plate-shaped members, the manipulator portion connected to the movement restricting portion so as to enable the user to manipulate the movement of the movement restricting portion.

2. The folding knife according to claim 1, further comprising an elastic member configured to bias the movement restricting portion in a direction from the second position toward the first position.

3. The folding knife according to claim 2, wherein
the locked portion is a first locked portion, and
a second locked portion is provided at the base end portion of the blade to lock the movement restricting portion which has moved toward the first position from the second position so that rotation of the blade in the first direction is restricted when the cutting-edge portion is accommodated in the accommodation space.

4. The folding knife according to claim 2, wherein
the movement restricting portion is configured to be movable between the first position and the second position which are aligned in a direction along a plate surface of the pair of plate-shaped members, and
the front end portion of the movement restricting portion has a tapered shape that gradually narrows in width in the direction from the second position toward the first position, and, when moving to the first position, is inserted into the gap between the stopper portion and a locked portion provided at the base end portion of the blade.

5. The folding knife according to claim 4, further comprising
a cylindrical member disposed between the pair of plate-shaped members and configured to accommodate a rear end portion of the movement restricting portion, wherein
the elastic member is formed from a coil spring and is accommodated inside the cylindrical member.

6. The folding knife according to claim 4, wherein
a through groove portion along a moving path of the movement restricting portion is provided in at least one of the pair of plate-shaped members,
the movement restricting portion includes a protruding portion on a side surface thereof, the protruding portion extending toward the outside of the pair of plate-shaped members through the through groove portion, and
the elastic member is disposed on the outside of the pair of plate-shaped members and is configured to bias the movement restricting portion via the protruding portion in the direction from the second position toward the first position.

7. The folding knife according to claim 6, wherein
the through groove portion is provided in each of the pair of plate-shaped members,
the movement restricting portion includes, as the protruding portion, a first protruding portion and a second protruding portion, each extending outward through each of the through groove portion of the pair of plate-shaped members, and
a first elastic member configured to bias the movement restricting portion through the first protruding portion and a second elastic member configured to bias the movement restricting portion through the second protruding portion are provided on the outside of the pair of plate-shaped members, as the elastic member.

8. The folding knife according to claim 2, wherein
an arcuate portion which is an arcuate-shaped outer peripheral edge portion centering around the rotation axis is provided at the base end portion of the blade, and
the locked portion is formed from an edge portion of a recessed portion provided at a position adjacent to the arcuate portion.

9. The folding knife according to claim 2, wherein
the elastic member is disposed between the pair of plate-shaped members, the elastic member formed from a plate spring, the plate spring having a rear end side which is fixed and a front end side that is displaceable in the thickness direction due to elastic deformation, and
the movement restricting portion is provided at the front end of the plate spring and moves between the first position and the second position which are aligned in the thickness direction due to the elastic deformation of the plate spring.

10. The folding knife according to claim 3, wherein
the movement restricting portion is configured to be movable between the first position and the second position which are aligned in a direction along a plate surface of the pair of plate-shaped members, and
the frontend portion of the movement restricting portion has a tapered shape that gradually narrows in width in the direction from the second position toward the first position, and, when moving to the first position, is inserted into the gap between the stopper portion and a locked portion provided at the base end portion of the blade.

11. The folding knife according to claim 5, further comprising
a cylindrical member disposed between the pair of plate-shaped members and configured to accommodate a rear end portion of the movement restricting portion, wherein
the elastic member is formed from a coil spring and is accommodated inside the cylindrical member.

12. The folding knife according to claim 5, wherein
a through groove portion along a moving path of the movement restricting portion is provided in at least one of the pair of plate-shaped members,
the movement restricting portion includes a protruding portion on a side surface thereof, the protruding portion extending toward the outside of the pair of plate-shaped members through the through groove portion, and
the elastic member is disposed on the outside of the pair of plate-shaped members and is configured to bias the movement restricting portion via the protruding portion in the direction from the second position toward the first position.

13. The folding knife according to claim 9, wherein
the through groove portion is provided in each of the pair of plate-shaped members,
the movement restricting portion includes, as the protruding portion, a first protruding portion and a second protruding portion, each extending outward through each of the through groove portion of the pair of plate-shaped members, and
a first elastic member configured to bias the movement restricting portion through the first protruding portion and a second elastic member configured to bias the movement restricting portion through the second protruding portion are provided on the outside of the pair of plate-shaped members, as the elastic member.

14. The folding knife according to claim 3, wherein
the elastic member is disposed between the pair of plate-shaped members, the elastic member formed from a plate spring, the plate spring having a rear end side which is fixed and a frontend side that is displaceable in the thickness direction due to elastic deformation, and
the movement restricting portion is provided at the front end of the plate spring and moves between the first position and the second position which are aligned in the thickness direction due to the elastic deformation of the plate spring.
